(19) United States
(12) Patent Application Publication
(10) Pub. No.: US 2006/0036408 A1
(43) Pub. Date: Feb. 16, 2006

(54) Method and system for processing evaluation data

(75) Inventors: Alexandre Templier, Paris (FR); Laurent Node-Langlois, Paris (FR); Ilhem Cherrak, Conflans Sainte Honorine (FR)

Correspondence Address: YOUNG & THOMPSON, 745 SOUTH 23RD STREET, 2ND FLOOR, ARLINGTON, VA, 22202, US

(73) Assignee: Surgiview, Paris (FR)

(21) Appl. No.: 10/534,297

(22) PCT Filed: Nov. 7, 2003
(86) PCT No.: PCT/FR03/03339

§ 371 Date: May 9, 2005

(30) Foreign Application Priority Data
Nov. 8, 2002 (FR) 02/14074

(51) Int. Cl. G06F 17/00

(52) U.S. Cl. 702/189

(57) ABSTRACT

A method for processing evaluation data includes a data acquisition phase where: a) at least one entity is generated as a function of the intrinsic characteristics of the entity, b) an initial status of the entity is generated and transmitted, c) an action is generated and transmitted as a function of the initial status, then d) resultant statuses are generated and transmitted during the evolutionary course of the entity at fixed times, the resultant statuses being at least a function of the initial status and the actions. The method further includes a second stage for use of the data, where statistical data is generated as a function of criteria fixed on following the structure of at least one of the actions a), b), c) and d) of the acquisition phase.

The present invention relates to a method and a system for processing evaluation data. It has a particularly useful application in any context where one wishes to analyze (evaluate) the effects of one or of several actions on a population of entities of the same nature being able to be in one or more initial states, the action or the actions considered inducing a modification of this initial state and an evolution of this state over time.

In particular, but not exclusively, the present invention relates to the medical field in which a user such as a doctor for example, wishes to follow the evolution of the state of a patient throughout the course of one or more treatments. However, the invention has a wider framework, since it could in particular apply to a system for the evaluation of businesses, the characteristics of which are liable to evolve over time depending on certain internal and external actions.

An aim of the present invention is to propose a module allowing the simple and rapid input of information of complex structure via a specific interface.

Another aim of the invention is to propose the processing of this information in a simple and rapid manner.

Another aim of the invention is to propose a module for the acquisition and processing of data being able to be adapted to numerous fields of application. At least one of the above-mentioned objectives is achieved with a method for processing evaluation data comprising a phase of acquiring data in which:
a) at least one entity is created as a function of the intrinsic characteristics of said entity,
b) an initial state of said entity is created and acquired,
c) an action is created and acquired as a function of the initial state, then
d) resultant states are created and acquired during the evolution of the state of said entity and at fixed times, said resultant states being at least a function of the initial state and the action.

Icons representing the Entities, states and actions thus created align themselves visually on a time line. The act of clicking on one of these icons gives access to the corresponding data.

The method also comprises a phase of processing the data in which the statistical data is generated as a function of criteria fixed by following the structure of at least one of the events a), b), c) and d) from the acquisition phase.

With such a method the processing of data is simplified as the criteria are obtained in the same manner as the information was acquired.

According to an advantageous characteristic of the invention, the data relative to each entity are stored in a first “Information” database, while the structure of the events is contained in a second independent “Metabase” database.

In other words, the Metabase is a database containing the description (hierarchy, structure and contents) of the different objects and events. It does not contain any information linked to the individual entities themselves. It serves only to describe the structure of the objects and events on which an acquisition model and usage models depend (sampling and analysis as described later).

The acquisition module allows for the creation of the different events and displaying their respective structures as a function of the information that it finds in the Metabase. The acquired data are then stored in the “Information” database.

The processing modules also depend on the Metabase to display the global and specific structure of the events, in order to allow the user to choose his criteria and his variables for processing.

Thus, the acquisition and processing modules are entirely independent of the structure of the events studied, and therefore of the “experience” of the user. These modules constitute a generic interface.

The structure of the events can evolve (addition or cancellation of events or items to be acquired): the modifications are then automatically passed on into the acquisition and processing modules.

This Metabase allows a simplified processing and upgradeability of the system according to the invention.

The structure of each event can be of a tree-and-branch (arborescent) type. The tree-and-branch type can be in the form of files in cascade or in graphic form or in any other form.

According to the invention, the processing can comprise a sampling stage in which a subpopulation of given entities is selected. As an extension in particular to what has gone before, the selection can be carried out by choosing at least one variable in the structure of at least one event a) , b) , c) or d), and in allocating a given constraint to this variable. This constraint can be a value or a set of values, or the character “acquired” or “not acquired”, allowing all the entities for which a specific variable has been acquired or not to be sampled.

The processing of data can also comprise an analysis stage in which statistical data are generated in the form of values, tables or graphs. Preferably, the sampling and the analysis are distinct, i.e. that one of the two functions can be carried out without the other. The analysis can also be carried out by choosing at least one variable in the structure of at least one event a), b), c) or d).

According to a method for implementing the invention, the events a), b), c) and d) are created in a chronological order, in particular progressively according to the activity of the user. Thus acquisition of the information is logical and simplified.

Preferably, acquisition is carried out by means of intuitive graphical interfaces. It is also possible to arrange several successive interfaces detailing the acquired elements.

As an example, the mode of acquisition can be via a keyboard, on touch screen or also by means of sound via a microphone.

In order to apply the invention to numerous fields, the structure of each event can be controlled by the Metabase.

According to another aspect of the invention, a system for processing evaluation data is proposed comprising the acquisition means for:
a) creating at least one entity as a function of the intrinsic characteristics of this entity,
b) creating and acquiring an initial state of said entity,
c) creating and acquiring an action as a function of the initial state, then
d) creating and acquiring, during the evolution of the state of said entity and at fixed times, resultant states, these resultant states being at least a function of the initial state and the action.

The system also comprises means for processing data to generate statistical data as a function of fixed criteria by following the structure of at least one of the events a), b), c) and d).

According to the invention, the means for processing data comprises a sampling module for selecting a subpopulation of given entities and an analysis module, preferably separate, for generating statistical data in the form of values, tables or graphs.

Advantageously, the acquisition and processing means can consist of generic interfaces capable of exploring the structure of the events.

Other advantages and characteristics of the invention will appear from the detailed examination of the description of a non-limitative method of implementation, and the attached drawings, in which:

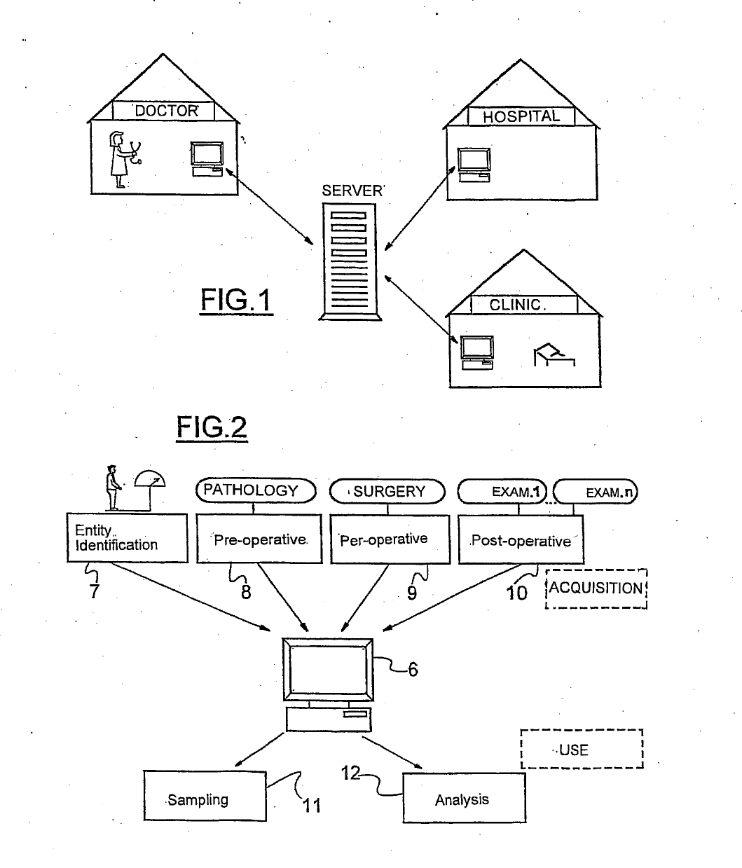

FIG. 1 is an overall diagrammatic view of the environment in which a system according to the invention can be integrated;

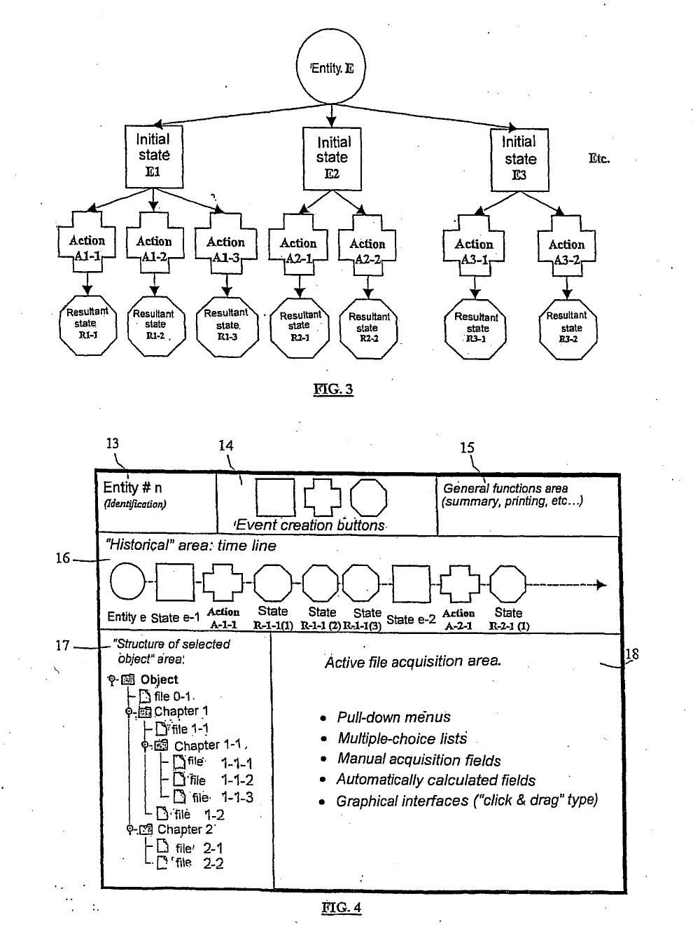

FIG. 2 is a diagram illustrating the events included in the acquisition phase as well as the processing modules for the processing phase;

FIG. 3 is a diagram illustrating the logical relationships between the structures of events;

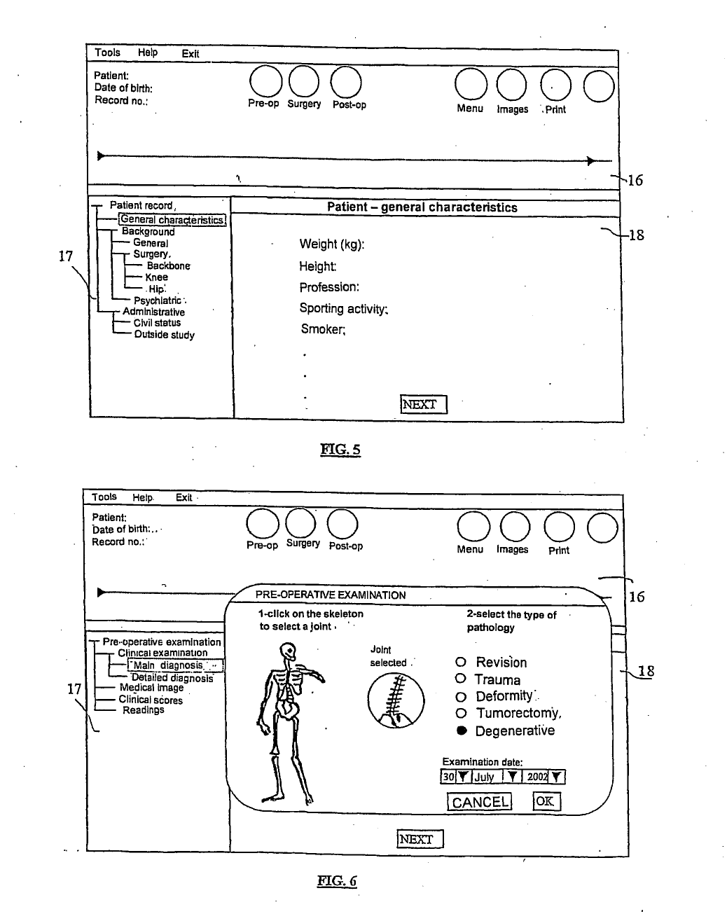

FIG. 4 is a diagram illustrating the principle of an acquisition interface according to the invention;

FIG. 5 is a diagram illustrating the principle of an acquisition interface during the patient identification phase;

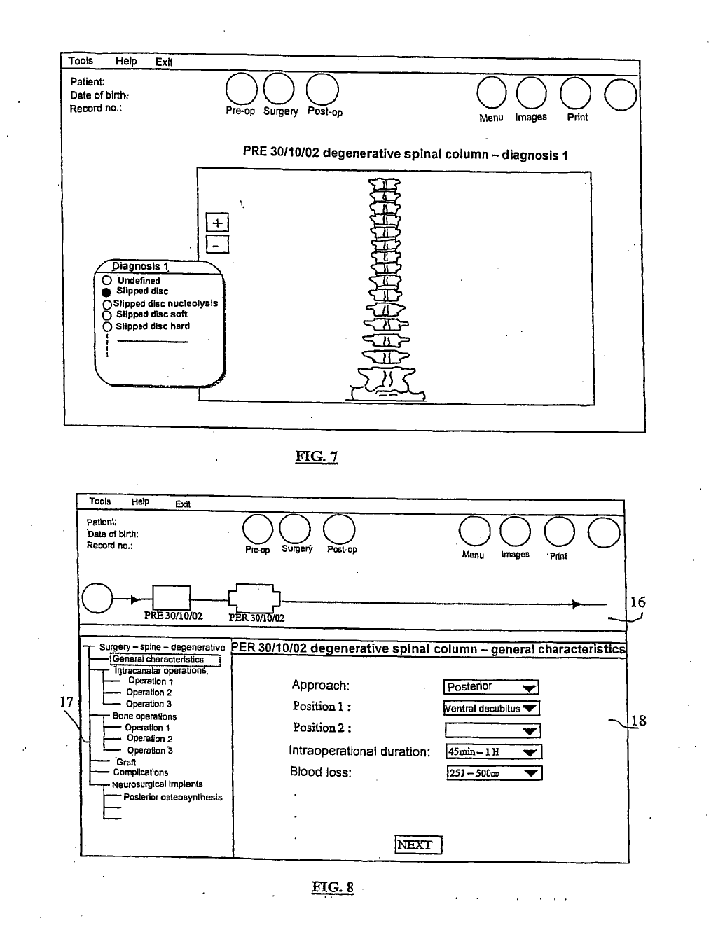

FIG. 6 is a diagram illustrating the principle of an acquisition interface during the patient's pre-operative examination;

FIG. 7 is a diagram illustrating the principle of an intuitive graphical acquisition interface during the patient's pre-operative examination;

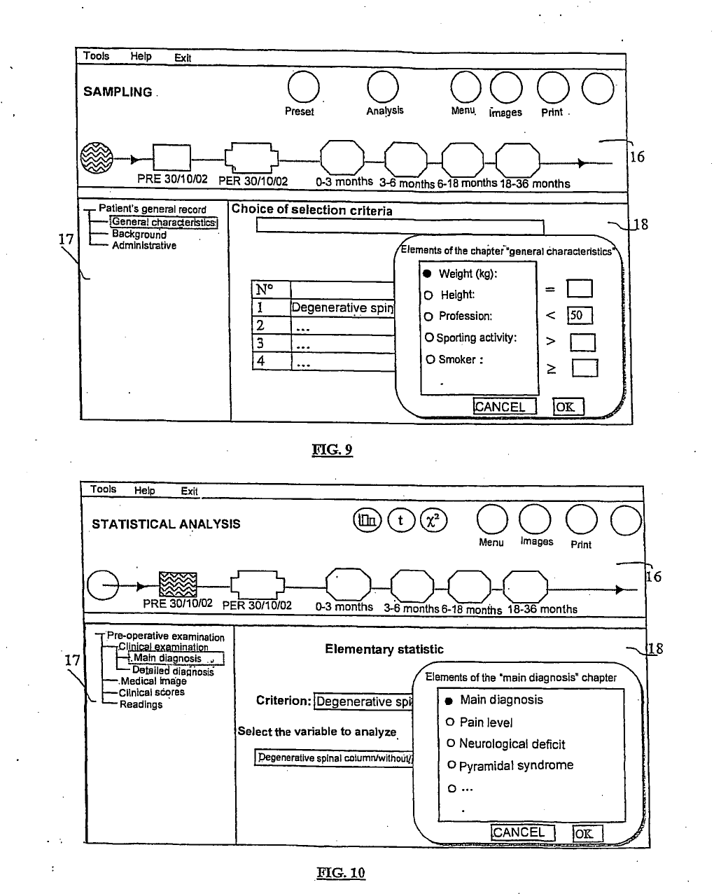

FIG. 8 is a diagram illustrating the principle of an acquisition interface during the patient's pre-operative examination (surgery);

FIG. 9 is a diagram illustrating the principle of a processing interface during a sampling;

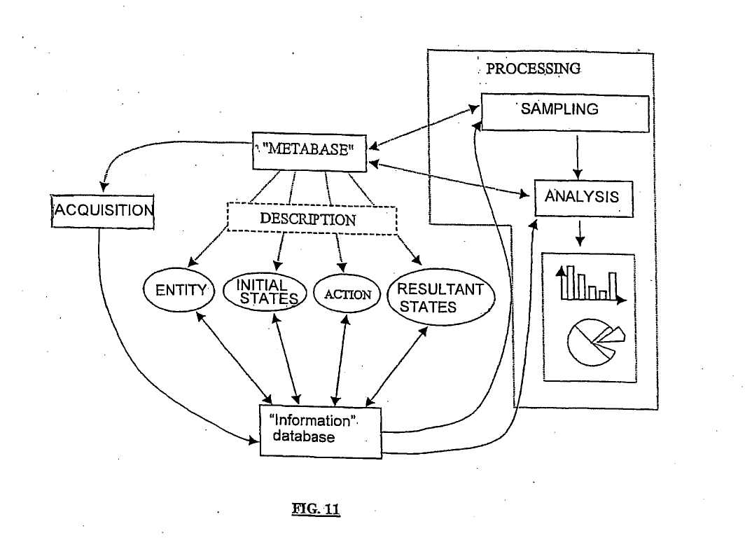

FIG. 10 is a diagram illustrating the principle of a processing interface during an analysis; and

FIG. 11 is a diagram illustrating a method for processing the sampling module and the analysis module according to the invention.

Although the invention is not limited by this, a method for acquiring and processing medical information will now be described. A doctor wishes to index and analyze all the data relative to his patients. He also wishes to follow the evolution of the state of each patient.

In FIG. 1 a system equipped with a data server 3 called “Server” can be seen. This data server assembles in an “Information” database all of the information relative to each patient for which the medical monitoring is carried out by means of a method according to the invention. The information can be acquired by a doctor 1 from a microcomputer 2 then transmitted to the server 3 for storage. They can then be shared with other institutions such as a clinic 4 or a hospital 5. The institutions 4 and 5 can also acquire the information to complete the patient's record.

The doctor and the institutions 4 and 5 each have a microcomputer used for implementing the method according to the invention. Each microcomputer comprises a “Metabase” database according to the invention in which the structure of different objects and events is described. However, in accordance with FIG. 2 for example, each microcomputer can contain both an “Information” database and a “Metabase” database.

FIGS. 2 and 3 show the logic path of the processing of data according to the invention.

In a general manner, in FIG. 2, a microcomputer 6 allowing the acquisition and processing of data according to the invention is shown. The microcomputer 6 contains an “Information” database and a parameterized “Metabase” database. In order to monitor the evolution of the state of a patient, the user, i.e. the doctor, will create all the events in a chronological order, as the activity patient's progresses. The first stage consists of the identification or the definition of the entity (the patient). This stage 7 can for example correspond to data such as the name and first name of the patient, the date of birth, a file number, the weight, the height, the profession, the sporting activity etc. These elements are characteristics intrinsic to the patient.

The following stage 8 relates to a pre-operative examination (diagnosis) during which the doctor examines the patient in order to define the pathology associated with this patient. The elements acquired by the doctor can be for example a degenerative spinal column in the form of a slipped disc, a consequence of which is the inability to walk. In order to bring this pathology under control, the doctor can then put into place a treatment such as a surgical operation, a course of drugs, or other. This treatment is a stage 9 of per-operative examination (therapeutic treatment). As described in FIG. 1, the surgical operation can be carried out in the clinic 4, and the information relating to this operation is therefore entered during stage 9.

Stage 10 is a post-operative stage (monitoring) during which the doctor carries out several examinations at fixed times in order to verify the evolution of the state of the patient. All of the information obtained during these examinations is integrated in the “Information” database within the micro-computer 6.

Stages 7 to 10 therefore relate to the acquisition stage. This information will be processed in order to obtain samplings 11 so as to select sub-populations from within all the entities. It is also possible to obtain analyses 12 to generate statistical data in the form of values, tables or graphs.

Each stage 7, 8, 9 or 10 of the acquisition phase constitutes an event. These events follow a particular chronology as represented in FIG. 3. The identification 7 of the patient therefore corresponds to a first stage during which the entity E is defined (the patient). This identification allows the intrinsic characteristics of the entity E to be acquired (FIG. 3) independently of its pathology. This pathology is determined during the pre-operative examination (diagnostic) 8 (FIG. 2) corresponding in fact to the definition of an initial state. Several initial states E1, E2 and E3 (FIG. 3) for example, can correspond to an entity E.

A given action such as for example a medical treatment or a surgical operation can be applied to each initial state. The actions A1-1, A1-2 or A1-3 can be applied to the initial state E1. Thus several actions can correspond to an initial state. On the other hand, one and only one resultant state Ri-i can correspond to an action. In fact, when a doctor examines a patient having followed a medical treatment, the state of the patient is the unique state observed at the moment of this post-operative examination. Of course, several post-operative (monitoring) examinations can follow, each giving a specific resultant state.

FIG. 4 is an example of an acquisition interface. This interface comprises an upper part comprising a first area 13 to indicate a few of the patient's identification elements such as for example name, first name, date of birth and corresponding file number. The upper part also comprises a second area 14 for the creation of pre-operative, per-operative and post-operative events; and a third area 15 of general information such as returning to a summary menu, starting printing or displaying images associated with the current event.

The acquisition interface also comprises an intermediate area 16 illustrating the time line. This historical area 16 comprises several events arranged one after the other in chronological order. The first element is the identification of entity E, the patient. The following event is the definition of an initial state E-1 obtained during a pre-operative examination (diagnostic). The medical treatment or the surgery carried out on the patient during the per-operative stage 9 corresponds to an action A1-1. Three post-operative examinations (monitoring) (R1-1(1), R1-1(2), R1-1(3)) are successively arranged on the time line before the definition of a second initial state E-2. This second initial state is followed by a second action A2-1 and a resultant state R2-1(1) corresponding to this second action.

By selecting the events arranged in the historical area 16, the structure of this event is developed in a lower left area 17. The structure represented in the area 17 is in tree-and-branch form. This type of structure can be the same for all the events, but it is also possible to have a given type of structure for each type of event. In the tree-and-branch structure of area 17, the selected event comprises the sub-events or files, and each sub-event also comprises other sub-events or other files and so on. Each file is controlled according to the user's wishes. In other words as a function of the activity (medical or not) of the user, the latter can define the tree-and-branch structure as well as the content of each file, sub-event and event. The parameterization is carried out within the “Metabase”. Any modification of the Metabase is automatically reflected in the acquisition and processing modules. By way of example, the description of events contained in the Metabase comprises in particular a hierarchy as represented in FIG. 3, and structures such as those represented in area 17 of FIG. 4.

The files include in particular variables which will then serve for sampling and analysis. These variables are in fact from the fields containing or not information acquired by the doctor. This information is introduced via an acquisition area 18 in different forms such as pull-down menus, multiple-choice lists, manual acquisition fields, automatically calculated fields, graphic interfaces . . . .

FIG. 5 is a view of an interface illustrating the acquisition of information during identification of the patient. Area 17 shows the detailed tree-and-branch form of the structure, and area 18 shows the type of data to be acquired.

FIG. 6 is a view corresponding to stage 8 of the pre-operative examination (diagnosis) during which the doctor defines in the first instance that it is a pathology of “degenerative spinal column” type with the graphical interfaces means representing the human skeleton as well as the zoom of a part of this skeleton pointed out by the doctor. FIG. 7 is a view of the continuation of the pre-operative examination (diagnosis) allowing the “degenerative spinal column” type to be defined more precisely. The doctor can therefore define that it is a slipped disc and specify the exact location on the spinal column. This definition is achieved by means of intuitive graphical interfaces, a type of graphical tree-and-branch structure, each part of the skeleton being parameterized.

Per-operative examination stage 9 (FIG. 2) shows a surgical operation for which an acquisition interface is represented as in FIG. 8. A tree-and-branch structure illustrating the sub-events and the files are shown in area 17. The selected file contains the general characteristics of the surgical operation (therapeutic action), these characteristics being detailed in area 18 of FIG. 8.

In the same way, the information relative to each post-operative examination (monitoring) can be acquired in the “Information” database.

The information acquired can then be manipulated so as to select for example a sub-population of patients using the sampling means (FIG. 9). An interface for defining a sample is represented in FIG. 9. The historical area 16 comprises several events. In order to carry out the sampling, the doctor must specify a part of the variable or variables to be taken into account as well as the constraints to be applied to this variable. Advantageously, to select the variable to be taken into account, the doctor selects one of the events displayed in the historical area 16. In FIG. 9, the event corresponding to “the identification of the patient” is selected, it is the first event. Thus, in area 17 the tree-and-branch structure corresponding to the event of identifying the patient is displayed. This is the same structure as that represented in area 17 of FIG. 5. The doctor will browse through the structure to select the desired variable, the weight in the case in point. He can then specify the constraint, for example a weight below 50 kg. In this way a sub-population of patients with weight below 50 kg has been simply isolated. Several sampling criteria can also be combined following logic operations (Boolean operations).

Once the sampling has been carried out, the sub-population of patients thus selected can then be analyzed.

The doctor can launch either a pre-established analysis such as one of the following types: elementary statistical, bivariate regression diagram, evolution diagram, survivor curve, non-parametric test (t or Khi 2) etc., or a new analysis which he will create by exploring the information available in the metabase.

To create the new analysis, the doctor needs to define a variable. To do this, he first selects an event in the historical area 16, in the pre-operative event space (diagnosis) (FIG. 10). In area 17 of FIG. 10 the tree-and-branch structure corresponding to the pre-operative event (diagnosis) selected is then displayed. The structure of area 17 of FIG. 6 is displayed again. The doctor can then browse through the structure until he finds the first variable “main diagnosis”.

FIG. 11 is a diagram illustrating the flow of information between the metabase, the “Information” database, the events, the sampling module and the analysis module. These last two modules fetch information from the meta-base in order to carry out their functions. The analysis function can moreover require data originating from the sampling to establish in particular the graphs 19. The flows in dotted lines relate to the “METABASE” data stream, and the flows in full lines relate to the data which has been acquired and processed. The events are created using data originating both from the METABASE and from the “Information” database. Similarly, the acquisition and the processing take into account the two databases.

Of course, the invention is not limited to the examples which have just been described and numerous adjustments can be made to these examples without exceeding the framework of the invention.

1. Method for processing evaluation data comprising a data acquisition phase in which:
a) at least one entity is created as a function of the intrinsic characteristics of said entity,
b) an initial state of said entity is created and acquired,
c) an action is created and acquired as a function of the initial state, then
d) resultant states are created and acquired during the evolution of the state of said entity and at fixed times, said resultant states being at least a function of the initial state and the action;
a second phase of processing the data in which the statistical data is generated as a function of criteria fixed by following the structure of at least one of the events a), b), c) and d) of the acquisition phase.

2. Method according to claim 1, characterized in that the data relative to each entity are stored in a first “Information” database, while the structure of the events is contained in a second independent “Metabase” database.

3. Method according to claim 1, characterized in that the processing comprises a sampling stage in which a sub-population of given entities is selected.

4. Method according to claim 3, characterized in that the selection is carried out by choosing at least one variable in the structure of at least one event a), b), c) or d), and by allocating a given constraint to this variable.

5. Method according to claim 1, characterized in that the processing comprises an analysis stage in which statistical data is generated in the form of values, tables or graphs.

6. Method according to claim 5, characterized in that the analysis is carried out by choosing at least one variable in the structure of at least one event a), b), c) or d).

7. Method according to claim 1, characterized in that the events a), b), c) and d) are created in chronological order.

8. Method according to claim 1, characterized in that acquisition is carried out by means of intuitive graphical interfaces.

9. Method according to claim 1, characterized in that the structure of each event is controlled by the metabase.

10. System for processing evaluation data comprising the acquisition means for:
a) creating at least one entity as a function of the intrinsic characteristics of this entity,
b) creating and acquiring an initial state of said entity,
c) creating and acquiring an action as a function of the initial state, then
d) creating and acquiring, during the evolution of the state of said entity and at fixed times, resultant states, these resultant states being at least a function of the initial state and the action;
and the means for processing data to generate statistical data as a function of fixed criteria by
following the structure of at least one of the events a), b), c) and d).

11. System according to claim 10, characterized in that it comprises a first “Information” database to store the data relative to each entity and a second independent “Metabase” database containing the structure of the events.

12. System according to claim 10, characterized in that the means of data processing comprise a sampling module to select a sub-population of given entities and an analysis module to generate statistical data in the form of values, tables or graphs.

13. System according to claim 11, characterized in that the acquisition and processing means consist of generic interfaces capable of exploring the structure of the events.

14. Method according to claim 2, characterized in that the processing comprises a sampling stage in which a sub-population of given entities is selected.

15. System according to claim 11, characterized in that the means of data processing comprise a sampling module to select a sub-population of given entities and an analysis module to generate statistical data in the form of values, tables or graphs.

16. System according to claim 12, characterized in that the acquisition and processing means consist of generic interfaces capable of exploring the structure of the events.
